(19) United States
(12) Patent Application Publication
(10) Pub. No.: US 2008/0157596 A1
(43) Pub. Date: Jul. 3, 2008

(54) Power distribution device of power storage apparatus

(76) Inventor: Ming-Hsiang Yeh, Taipei City (TW)

Correspondence Address: TROXELL LAW OFFICE PLLC, 5205 LEESBURG PIKE SUITE 1404, FALLS CHURCH, VA, 22041, US

(21) Appl. No.: 11/647,372

(22) Filed: Dec. 29, 2006

(51) Int. Cl. H02J 3/00; H02J 9/00

(52) U.S. Cl. 307/23; 307/39

(57) ABSTRACT

A power distribution device of a power storage apparatus comprises a power source and an uninterruptible power supply (UPS) system, wherein the UPS system has a built-in power output selector. An input terminal of the UPS system is connected to the power source. An output terminal of the UPS system is connected to several electric appliances via the built-in power output selector. As a result, no matter whether the power source supplies or not supplies the electric power, the built-in power output selector of the UPS system is able to supply the electric power to designated electric appliances according to the predetermined priority sequence and timing.

### FIELD OF THE INVENTION

The present invention relates to a power distribution device of a power storage apparatus having the planning ability to determine the priority sequence and the timing to supply the electric power and this power distribution device is more particularly suitable for use in escape, lighting, precision instruments, or the like.

### BACKGROUND OF THE INVENTION

With raising oil prices, there are increasing awareness of the concepts of environmental protection, automation, and saving energy. Among which, the need for automation is most obvious in particular. Traditionally, the automation design is only applicable to the machine themselves. However, it becomes invalid when the electric power is out.

Although there are many different kinds of uninterruptible power supply (UPS) systems in the market for supplying the auxiliary electric power for the electric appliances, these conventional UPS systems supply the electric power for all of the electric appliances simultaneously and can not decide the priority sequence.

For instance, if there is a fire accident in a building, the firemen will shut off the main power switch first before relieving the victims of the fire accident. However, once the main power switch is shut off, the emergency doors, the escape indication and emergency lights, and ventilation system will be failed, causing an even greater disaster.

In view of the foregoing description, the motive of the present invention is to provide the general public with a power distribution device of a power storage apparatus, which is capable of supplying the electric power according to the predetermined priority sequence and timing.

### SUMMARY OF THE INVENTION

A major object of the present invention is to provide a power distribution device of a power storage apparatus, which is capable of supplying the electric power according to the predetermined priority sequence and timing.

In order to achieve the above-mentioned object, a power distribution device of a power storage apparatus is comprised of a power source and an uninterruptible power supply (UPS) system, wherein the UPS system has a built-in power output selector. An input terminal of the UPS system is connected to the power source. An output terminal of the UPS system is connected to several electric appliances via the built-in power output selector. As a result, no matter whether the power source supplies or not supplies the electric power, the built-in power output selector of the UPS system is able to supply the electric power to designated electric appliances according to the predetermined priority sequence and timing.

The aforementioned object and other advantage of the present invention will be readily clarified in the description of the preferred embodiments and the enclosed drawings of the present invention.

### BRIEF DESCRIPTION OF THE DRAWINGS

FIG. 1 is a schematic block diagram showing the skeleton of a preferred embodiment of the present invention.

FIG. 2 is a block diagram showing the usage of the preferred embodiment of the present invention.

### DETAILED DESCRIPTION OF THE PREFERRED EMBODIMENT

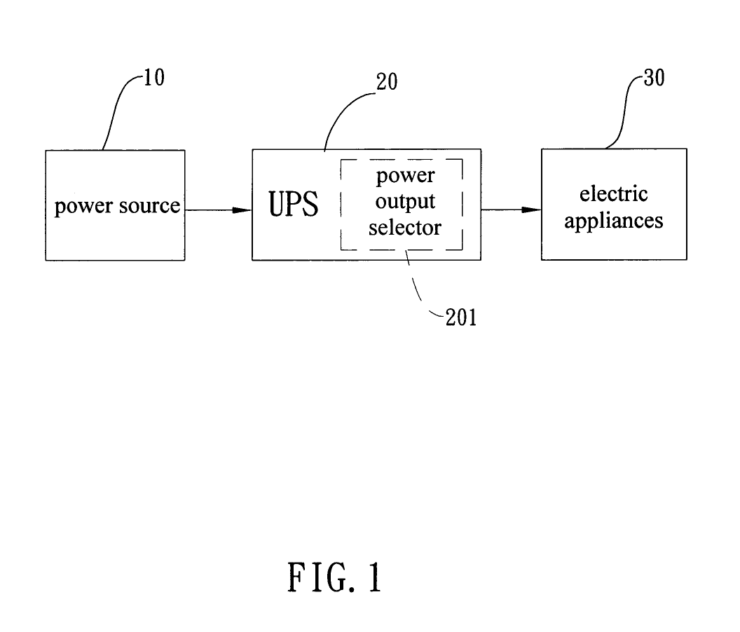

Referring to FIG. 1, a power distribution device of a power storage apparatus of the present invention generally comprises a power source 10 and an uninterruptible power supply (UPS) system 20, wherein the power source 10 is an alternating current (AC) power source or a direct current (DC) power source such as a commercial power service or any generator selected from a manpower bicycle generator, a fuel generator, a battery generator, a wind power generator, a fuel cell generator, a solar power generator, and so on. An input terminal of the UPS system 20 is connected to the power source 10. The UPS system 20 has a built-in power output selector 201 having the timing function and the software and hardware planning ability. The UPS system 20 is connected to several electric appliances 30 via the built-in power output selector 201. The power output selector 201 determines the priority sequence by using the software or the hardware such as a relay, a reed switch, or a motor. As a result, these electric appliances 30 can be controlled by the power output selector 201 to determine which one should be stopped and which one should be running when the power source 10 stops the electric power supply.

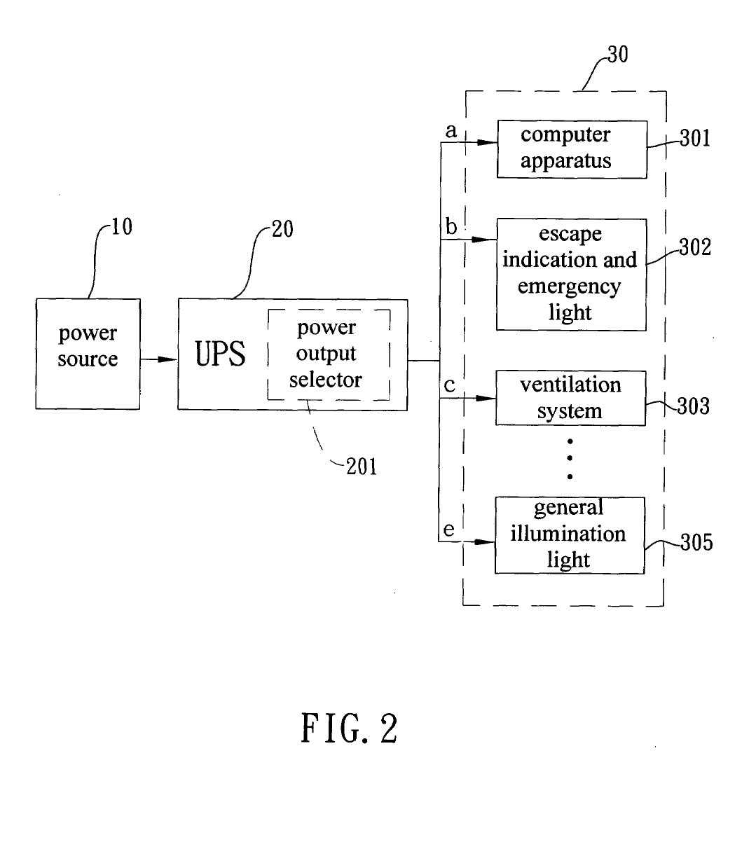

As shown in FIG. 2, the electric appliances 30 comprise a computer apparatus 301, an escape indication and emergency light 302, a ventilation system 303, a general illumination light 305, and so on. In this preferred embodiment, the power source 10 is exemplified by the commercial power service. If the commercial power service is normally available, the UPS system 20 can supply the commercial power to the electric appliances 30 that couple thereto and can also store the commercial power. Moreover, if the commercial power service is normally available, the UPS system 20 can supply the commercial power to the electric appliances 30 according to the priority sequence and the timing set by the built-in power output selector 201. In addition, the UPS system 20 can output the stored power according to the priority sequence and the timing set by the built-in power output selector 201 when the power source 10 stops the supply of commercial power. In other words, the power output selector 201 first supplies the electric power to the computer apparatus 301 of priority sequence a so as to provide the computer apparatus 301 with adequate time to backup data. If the time for supply of electric power for the priority sequence a expires, the power output selector 201 next supplies the electric power to the escape indication and emergency light 302 of priority sequence b and the ventilation system 303 of priority sequence c so as to provide the accidented building with good ventilation effect and good escape indication and emergency lighting, thereby preventing the escape route of the people in the building from being obstructed. If the time for supply of electric power for the priority sequence b and priority sequence c expires, the power output selector 201 next supplies the electric power to the general illumination light 305 of priority sequences e.

Furthermore, the power output selector 201 can be optionally controlled by a wireless remote control such as a mobile phone (GSM, PHS, CDMA, and so on), a Bluetooth device, a RF (Radio Frequency) device, or a WLAN (Wireless LAN) device, or a wireless remote technology controlled by PLN (Power Line Communications) technology. As a result, the user can supply the electric power to designated electric appliances 30 or interrupt the supply of electric power depending on the condition at that time so as to prevent the island effect from occurring at this fire scene, for example. Most people think that the electric power will be cut off after the main power switch is turned off. However, the UPS system still supplies the fire scene with the electric power, causing the firemen very dangerous. As a result, if the wireless remote control is coupled with the main power switch, and if the main power switch is turned off, the wireless remote control will instruct the power source selector 201 to stop the supply of electric power immediately, thereby avoiding the above-mentioned danger.

In accordance with the foregoing description, the present invention has the following advantages:

1. The UPS system uses the built-in power source selector to set the priority sequence and the timing for supplying the electric power so as to achieve the purpose of saving energy.

2. If the power source changes or under certain conditions, the power output selector can control the supply of electric power for some apparatuses to operate these apparatuses normally or stop them according to the quality of electric power and the cost or other concerns. In addition, the electric power can be supplied during certain periods so as to save the cost and things like that.

3. The UPS system or the power output selector is optionally coupled with a wireless remote control so as to force the power output selector of the UPS system to stop the supply of electric power or adjust the priority sequence and timing of supplying the electric power.

In summary, a power distribution device of a power storage apparatus of the present invention indeed achieves the anticipated object. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A power distribution device of a power storage apparatus, comprising:
a power source; and
an uninterruptible power supply (UPS) system having a built-in power output selector having a timing function and a software and hardware planning ability, said UPS system having an input terminal connected to said power source and an output terminal connected to a plurality of electric appliances via said power output selector, whereby no matter whether said power source supplies or not supplies the electric power, said built-in power output selector of said UPS system is able to or unable to supply the electric power to a plurality of designated electric appliances among said electric appliances according to a predetermined condition.

2. A power distribution device of a power storage apparatus of claim 1, wherein said power source is an alternating current (AC) power source or a direct current (DC) power source.

3. A power distribution device of a power storage apparatus of claim 1, wherein said power source is a commercial power service or any generator.

4. A power distribution device of a power storage apparatus of claim 1, wherein said power output selector of said UPS system is software.

5. A power distribution device of a power storage apparatus of claim 1, wherein said power output selector of said UPS system is hardware selected from a relay, a reed switch, or a motor.

6. A power distribution device of a power storage apparatus of claim 1, wherein said power output selector is controlled by a wireless remote control controlled by a wireless remote control technology selected from RF (Radio Frequency), Bluetooth, GSM, CDMA, PHS, or WLAN (Wireless LAN).

7. A power distribution device of a power storage apparatus of claim 1, wherein said power output selector is controlled by a wireless remote control controlled by a PLN (Power Line Communications) technology.
